(19) United States
(12) Patent Application Publication
(10) Pub. No.: US 2009/0188089 A1
(43) Pub. Date: Jul. 30, 2009

(54) Metal Coffin with Wooden Structure and the Method of Producing the same

(76) Inventor: Tizhong Xue, Wuxi (CN)

Correspondence Address: IVY Y. MEI, 800 EL CAMINO REAL W., SUITE 180, MOUNTAIN VIEW, CA, 94040, US

(21) Appl. No.: 12/335,543

(22) Filed: Dec. 16, 2008

(30) Foreign Application Priority Data
Jan. 29, 2008 (CN) 2008100205754

(51) Int. Cl. A61G 17/007

(52) U.S. Cl. 27/5

(57) ABSTRACT

The present invention provides a coffin, in particular a metal coffin with wooden structure. According to the present invention, a metal coffin has a coffin body (3) and a lid (2). The coffin body has at least one wooden strip (1) on at least one of the coffin body (3) and the lid (2). The wooden strip (1) can be located on an outer surface of at least one of the lid (2) and/or the coffin body (3). The metal coffin with wooden structure includes at least one groove on the lid (2) and the coffin body (3). By utilizing the wooden strips with decorative functions the level of coffin is highly improved.

### FIELD OF THE INVENTION

The present invention relates to a coffin, in particular a metal coffin with wooden structure.

### BACKGROUND OF THE INVENTION

In areas where cremation is encouraged, a coffin is not used. While in some areas, it is common to bury a deceased person by containing one in a coffin. In current state of art, a coffin is usually made of anticorrosive hard wood. As society progresses and technology develops, anticorrosive metal is used to manufacture a coffin. Not only can the use of anticorrosive metal greatly reduce the need for timber but also can it prolong the preservation of dead bodies. The current metal coffins, however, are made of pure metals and lack in styles; therefore they are hard to fulfill the demands of consumers.

### SUMMARY OF THE INVENTION

The object of the present invention is to provide a metal coffin with wooden structure. By using wooden strips with decorative functions, it highly improves the level of coffin. According to the technical solution of the present invention, a metal coffin has a wooden structure and the metal coffin comprising a coffin body (3) and a lid (2), characterized by: at least one wooden strip (1) on at least one of the coffin body (3) and the lid (2).

A metal coffin having a wooden structure is further characterized by: the at least one wooden strip (1) being on an outer surface of at least one of the lid (2) and the coffin body (3).

A metal coffin having a wooden structure is further characterized by: at least one groove on the lid (2) and the coffin body (3), wherein the at least one wooden strip (1) is mounted in the at least one groove.

A metal coffin having a wooden structure is further characterized by: the at least one wooden strip (1) mounted on at least one of the lid (2) and the coffin body (3) via adhesive, screw-bolt, or rivet.

A metal coffin having a wooden structure is further characterized by: the at least one wooden strip (1) having a shape of long rectangle, short rectangle, oval, circle, ellipse or irregular shape.

A metal coffin having a wooden structure is further characterized by: a portion of the surface of the at least one wooden strip (1) projecting above a surface of at least one of the lid (2) and the coffin body (3).

A metal coffin having a wooden structure is further characterized by: the coffin body (3) having a base panel and four side panels at four sides of the coffin body, and a middle portion of a cross-section of the lid (2) projecting upward.

A metal coffin having a wooden structure is further characterized by: a plurality of fastening bases configured on the upper portion of the coffin body, a fastening rod mounted between the fastening bases, and a handle attached to the rod, the handle forming a hole adapted for a hand to hold on the handle.

A metal coffin having a wooden structure as is further characterized by a locking mechanism disposed in a channel near an upper edge of a side panel of the coffin body, the locking mechanism having a pulling rod, a hook attached to the pulling rod, an adjustment rod coupled to a right end of the pull rod, a locking hook-up disposed on the lid, the locking hook-up having a locking base insertable into a lock hole on the upper edge of the side panel to engage the hook.

A metal coffin having a wooden structure is further characterized by: a connection base mounted on an upper portion of the coffin body, a connection rod connected to the connection base via hinge, a pulling rod connected to one end of the connection rod, and a sealing strip configured on an upper edge of the coffin body.

One of the advantages of present invention is, by utilizing wooden strips with decorative functions arranged on the lid and/or the coffin body, the metal coffin of the present invention has a style of nobility.

A sealing strip and a locking mechanism are provided between the coffin body and the lid. When the lid is closed and locked by the locking mechanism, the metal coffin is sealed in order to prevent smell from leaking to outside and improve the sanitary condition of the coffin. In this way, the preservation of the dead bodies is prolonged. A movable pulling rod is connected to the coffin body so the coffin can be moved easily. When the coffin is not moved, the movable pulling rod can be snapped downward to save space and to facilitate the move of the coffin. When a fixed pulling rod is connected to the coffin body, a mover just needs to grasp the pulling rod to move the coffin.

### BRIEF DESCRIPTION OF THE DRAWINGS

FIG. 1 is a front view of the coffin according to the present invention;

FIG. 2 is a top view of the coffin according to the present invention; and

FIG. 3 is a left view of the coffin according to the present invention;

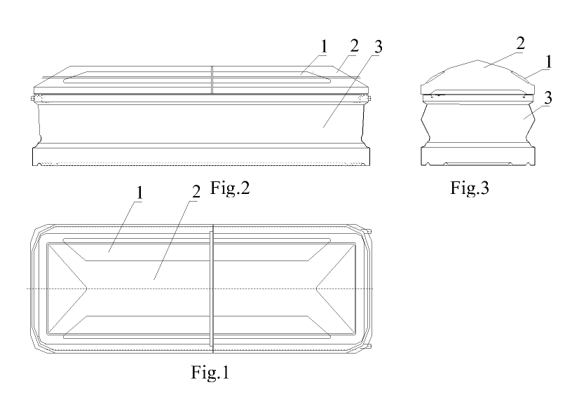

### DETAILED DESCRIPTION OF THE PREFERRED EMBODIMENTS

As shown in the figures, a metal coffin has a coffin body (3) and a lid (2). The coffin body has at least one wooden strip (1) on at least one of the coffin body (3) and the lid (2). The wooden strip (1) can be located on an outer surface of at least one of the lid (2) and/or the coffin body (3).

One embodiment of the present invention includes at least one groove on the lid (2) and the coffin body (3). The wooden strip (1) is mounted in the groove. The wooden strip can be mounted on the lid (2) and/or the coffin body (3) via adhesive, screw-bolt, or rivet.

The wooden strip (1) can have a shape of long rectangle, short rectangle, oval, circle, ellipse or irregular shape. A portion of the surface of the at least one wooden strip (1) projecting above a surface of at least one of the lid (2) and the coffin body (3).

The coffin body (3) has a base panel and four side panels at four sides of the coffin body, and a middle portion of a cross-section of the lid (2) projecting upward.

A plurality of fastening bases configured on the upper portion of the coffin body, a fastening rod mounted between the fastening bases, and a handle attached to the rod, the handle forming a hole adapted for a hand to hold on the handle.

A metal coffin having a wooden structure as has a locking mechanism disposed in a channel near an upper edge of a side panel of the coffin body, the locking mechanism having a pulling rod, a hook attached to the pulling rod, an adjustment rod coupled to a right end of the pull rod, a locking hook-up disposed on the lid, the locking hook-up having a locking base insertable into a lock hole on the upper edge of the side panel to engage the hook.

A metal coffin having a wooden structure has a connection base mounted on an upper portion of the coffin body, a connection rod connected to the connection base via hinge, a pulling rod connected to one end of the connection rod, and a sealing strip configured on an upper edge of the coffin body.

What is claimed is

1. A metal coffin having a wooden structure, the metal coffin comprising a coffin body (3) and a lid (2), characterized by: at least one wooden strip (1) on at least one of the coffin body (3) and the lid (2).

2. A metal coffin having a wooden structure as claimed in claim 1, further characterized by: the at least one wooden strip (1) being on an outer surface of at least one of the lid (2) and the coffin body (3).

3. A metal coffin having a wooden structure as claimed in claim 1, further characterized by: at least one groove on the lid (2) and the coffin body (3), wherein the at least one wooden strip (1) is mounted in the at least one groove.

4. A metal coffin having a wooden structure as claimed in claim 1, further characterized by: the at least one wooden strip (1) mounted on at least one of the lid (2) and the coffin body (3) via adhesive, screw-bolt, or rivet.

5. A metal coffin having a wooden structure as claimed in claim 1, further characterized by: the at least one wooden strip (1) having a shape of long rectangle, short rectangle, oval, circle, ellipse or irregular shape.

6. A metal coffin having a wooden structure as claimed in claim 1, further characterized by: a portion of the surface of the at least one wooden strip (1) projecting above a surface of at least one of the lid (2) and the coffin body (3).

7. A metal coffin having a wooden structure as claimed in claim 1, further characterized by: the coffin body (3) having a base panel and four side panels at four sides of the coffin body, and a middle portion of a cross-section of the lid (2) projecting upward.

8. A metal coffin having a wooden structure as claimed in claim 1, further characterized by: a plurality of fastening bases configured on the upper portion of the coffin body, a fastening rod mounted between the fastening bases, and a handle attached to the rod, the handle forming a hole adapted for a hand to hold on the handle.

9. A metal coffin having a wooden structure as claimed in claim 1, further characterized by: a locking mechanism disposed in a channel near an upper edge of a side panel of the coffin body, the locking mechanism having a pulling rod, a hook attached to the pulling rod, an adjustment rod coupled to a right end of the pull rod, a locking hook-up disposed on the lid, the locking hook-up having a locking base insertable into a lock hole on the upper edge of the side panel to engage the hook.

10. A metal coffin having a wooden structure as claimed in claim 1, further characterized by: a connection base mounted on an upper portion of the coffin body, a connection rod connected to the connection base via hinge, a pulling rod connected to one end of the connection rod, and a sealing strip configured on an upper edge of the coffin body.
